(19) United States
(12) Patent Application Publication
(10) Pub. No.: US 2020/0121126 A1
(43) Pub. Date: Apr. 23, 2020

(54) GASTRONOMY ROLLER HEATER

(71) Applicant: Dariusz Wadolowski, Pisz (PL)

(72) Inventor: Dariusz Wadolowski, Pisz (PL)

(21) Appl. No.: 16/723,913

(22) Filed: Dec. 20, 2019

Related U.S. Application Data
(63) Continuation of application No. PCT/PL2018/000063, filed on Jun. 19, 2018.

(30) Foreign Application Priority Data
Jun. 20, 2017 (PL) P.421960

(51) Int. Cl. A47J 37/04; A47J 36/32

(52) U.S. Cl. CPC A47J 37/049; A47J 36/32; A47J 37/048

(57) ABSTRACT

A gastronomy roller heater is provided having a cuboid base with a socket for connecting electric current, and equipped from the front with a thermostat, a power switch and an operating indicator, over which, between the side walls, rotating heating rollers are mounted. The upper parts of the side walls are formed in the shape of a ventilation hood fitted with temperature sensors with the non-contact temperature sensors directed at the inter-rows of heating rollers. The upper surface of the side walls are temperature displays mounted, presenting the temperature measured by individual temperature sensors.

### CROSS REFERENCE TO RELATED APPLICATIONS

This application is a continuation under 35 U.S.C. § 120 of International Application PCT/PL2018/000063, filed Jun. 19, 2018, which claims priority to Polish Application No. P. 421960, filed Jun. 20, 2017, the contents of each of which are incorporated by reference herein.

### FIELD OF THE INVENTION

This disclosure relates to a gastronomy roller heater used for heating cured meat products mainly for purposes of small gastronomy.

### BACKGROUND

Roller heater are known as heaters mainly for hot dogs and are equipped with rotating heating rolls inside of which heaters are mounted. The heaters are equipped with a thermostat and a control lamp. The heated cured meat products are usually wieners or kabanos sausages for hot dogs and the heater allows the simultaneous heating from a few to a dozen or even several dozens of such sausages. During the sale of hot dogs it is impossible to predict the quantity and types of sausages that will be ordered by the customers. This causes a situation in which some sausages are heated for a long time while others are heated on a regular basis. This requires observation of the device and paying special attention to the heated products which, in the case of selling hot dogs at, for example, gas stations, where the staff provides various sale services under time pressure, can lead to the issue of selling hot dogs with insufficiently heated sausages.

The gastronomy roller heater having a cuboid base fitted with a socket for connecting the electric current, and equipped in the front with a thermostat, a power switch and an operating indicator over which, between the side walls, rotating heating rollers are mounted characterized by the fact, according to the invention, that the upper part of the side walls is formed in the shape of a ventilation hood, fitted with non-contact temperature sensors, with the temperature sensors being directed at the inter-rows of the heating rollers, and on the upper surface of the side walls are located temperature displays presenting the temperature measured by individual temperature sensors.

Beneficially, the temperature sensors are non-contact infrared sensors. The sausages rotate in the inter-rows of the rotating rolls, and the displays indicate temperature measured with temperature sensors. The sensors are directed at the inter-rows of the rollers, that is at the places where the heated sausages are located. By using this solution it is possible to monitor the temperature of the heated sausages on the ongoing basis, which allows providing the proper quality of the served hot-dogs as well as meeting the terms of food safety requirements, ensuring protection of human health and consumer interests.

### BRIEF DESCRIPTION OF THE DRAWINGS

FIG. 1 shows the roller heater in a front perspective view.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

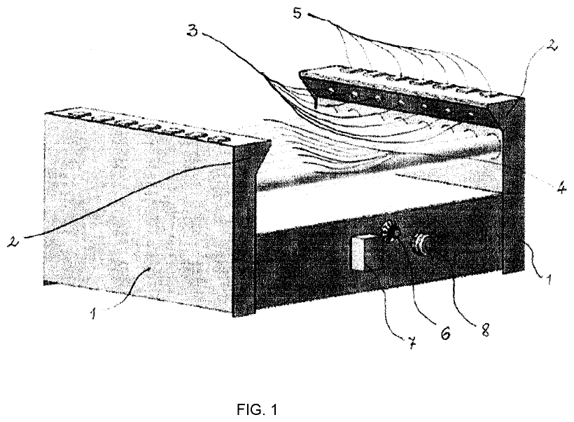

The invention is explained in greater details in the exemplary embodiment displayed in the drawing of FIG. 1, which shows the roller heater in a front perspective view.

The gastronomy roller heater has a cuboid stainless steel base fitted with a socket for connecting the electric current and is equipped from the front with a thermostat 6, a power switch 7 and an operating indicator 8. Above the base, between the side walls 1, rotating heating rollers are mounted 4. The upper parts of the side walls 1 are formed in the shape of a ventilation hood 2, fitted with non-contact infrared temperature sensors 3. Temperature sensors 3 are directed at the inter-rows of the rollers 4. On the upper side of the side walls 1 are placed temperature displays 5 showing the temperature measured by individual temperature sensors 3. The temperature of each of the sausages heated in the inter-rows is presented on the corresponding temperature display.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A gastronomy roller heater comprising
a cuboid base fitted with a socket for connecting electric current, and equipped from the front with a thermostat, a power switch and an operating indicator, over which, rotating heating rollers are mounted between the side walls; wherein
the upper parts of the side walls are formed in the shape of a ventilation hood fitted with temperature sensors with the non-contact temperature sensors directed at the inter-rows of heating rollers; wherein on the upper surface of the side walls are temperature displays mounted presenting the temperature measured by individual temperature sensors.

2. The roller heater according to claim 1, wherein the temperature sensors are non-contact infrared sensors.
